(19) United States
(12) Patent Application Publication
(10) Pub. No.: US 2015/0010687 A1
(43) Pub. Date: Jan. 8, 2015

(54) ENCASED SOLID FOOD AND METHOD FOR MANUFACTURING THE SAME

(71) Applicant: Daiwa Can Company, Tokyo (JP)

(72) Inventors: Hiroshi BATORI, Sagamihara-shi (JP); Toshiyuki AKACHI, Sagamihara-shi (JP); Shintarou HASHIMOTO, Sagamihara-shi (JP); Minami TANOUE, Sagamihara-shi (JP); Takafumi KAKUMA, Sagamihara-shi (JP)

(21) Appl. No.: 14/492,625

(22) Filed: Sep. 22, 2014

Related U.S. Application Data
(63) Continuation of application No. PCT/JP2013/058435, filed on Mar. 22, 2013.

(30) Foreign Application Priority Data
Mar. 28, 2012 (JP) 2012-074618

(51) Int. Cl. A23L 1/00

(52) U.S. Cl. CPC A23L 1/0097; A23L 1/0073; A23V 2002/00
USPC 426/568; 426/564

(57) ABSTRACT

According to the present invention, an encased mousse-form solid food is provided. The encased mousse-form solid food includes a container with an opening, a mousse-form solid body contained inside the container, a viscous liquid contained inside the container and covering a circumference of the mousse-form solid body, and a lid attached to the opening of the container. The mousse-form solid body has a hardness of 1.0×10⁴ N/m² or more and 5.0×10⁴ N/m² or less. The viscous liquid has a viscosity of 0.5 Pa·s or more and 10.0 Pa·s or less.

### CROSS-REFERENCE TO RELATED APPLICATION

This application is Continuation Application of PCT Application No. PCT/JP2013/058435, filed Mar. 22, 2013 and based upon and claiming the benefit of priority from the Japanese Patent Application No. 2012-074618, filed Mar. 28, 2012, the entire contents of all of which are incorporated herein by reference.

### FIELD

The present invention relates to an encased solid food and a method for manufacturing the same.

### BACKGROUND

Conventionally, there has been provided an encased food which contains an ingredient, such as a vegetable that can easily collapse during cooking, along with a seasoning liquid in a sealed state, to prevent the ingredient from collapsing during transportation.

In recent years, as a care food for elderly people or the like who have difficulty in chewing and swallowing, there is distributed a food that has been produced by grinding a solid food and then solidifying and reshaping it in a mousse-form state. Such a mousse-form food is good in appearance and is soft enough to easily swallow.

The hardness of care foods is prescribed in a standard of Universal Design Food. This hardness is set at a hardness of 5×10⁴ N/m² or less or a hardness of 2×10⁴ N/m² or less, depending on the situation of swallowing. Mousse-like foods according to this hardness are very soft. Particularly, mousse-form foods made from a protein, such as egg albumen, and/or a starch, such as dextrin, are less elastic and can more easily collapse, as compared with foods made from gelatin, when they have the same hardness. Accordingly, mousse-form foods of this type are distributed in a frozen state in general. Frozen mousse-form foods are thawed and then served for eating.

### PRIOR ART REFERENCE

### Patent Document

[Patent Document 1]

Jpn. Pat. Appln. KOKAI Publication No. 2006-55076

[Patent Document 2]

Jpn. Pat. Appln. KOKAI Publication No. 2006-304719

### SUMMARY OF THE INVENTION

### Problem to be Solved by the Invention

An object of the present invention is to provide an encased mousse-form food that does not require freezing for distribution.

### Means for Solving the Problem

According to the present invention, there is provided an encased mousse-form solid food. The encased mousse-form solid food comprises a container with an opening, a mousse-form solid body contained inside the container, a viscous liquid contained inside the container and covering a circumference of the mousse-form solid body, and a lid attached to the opening of the container. The mousse-form solid body has a hardness of 1.0×10⁴ N/m² or more and 5.0×10⁴ N/m² or less. The viscous liquid has a viscosity of 0.5 Pa·s or more and 10.0 Pa·s or less.

### Advantageous Effect of Invention

According to one embodiment, there is provided an encased mousse-form food that does not require freezing for distribution.

### BRIEF DESCRIPTION OF THE SEVERAL VIEWS OF THE DRAWING

FIG. 1A is a perspective view illustrating an encased mousse-form food.

FIG. 1B is a sectional view taken along a line B-B.

FIG. 1C is a plan view illustrating a lid.

FIG. 2A is a graph showing the hardness of mousse-form solid bodies.

FIG. 2B is a graph showing the hardness of mousse-form solid bodies.

FIG. 2C is a graph showing the hardness of mousse-form solid bodies.

FIG. 3A is a model graph showing the hardness of egg albumen mousse.

FIG. 3B is a model graph showing the hardness of starch mousse.

FIG. 3C is a model graph showing the hardness of mousse of mixture of egg albumen mousse and starch.

FIG. 3D is a model graph showing the hardness of radish.

FIG. 3E is a model graph showing the hardness of carrot.

FIG. 3F is a model graph showing the hardness of potato.

FIG. 3G is a model graph showing the hardness of codfish.

FIG. 3H is a model graph showing the hardness of flatfish.

FIG. 3I is a model graph showing the hardness of hanppen.

FIG. 3J is a model graph showing the hardness of pork belly.

FIG. 3K is a model graph showing the hardness of beef fibrous meat.

FIG. 3L is a model graph showing the hardness of jelly.

FIG. 3M is a model graph showing the hardness of pudding. FIG. 3N is a model graph showing the hardness of tofu.

### DETAILED DESCRIPTION

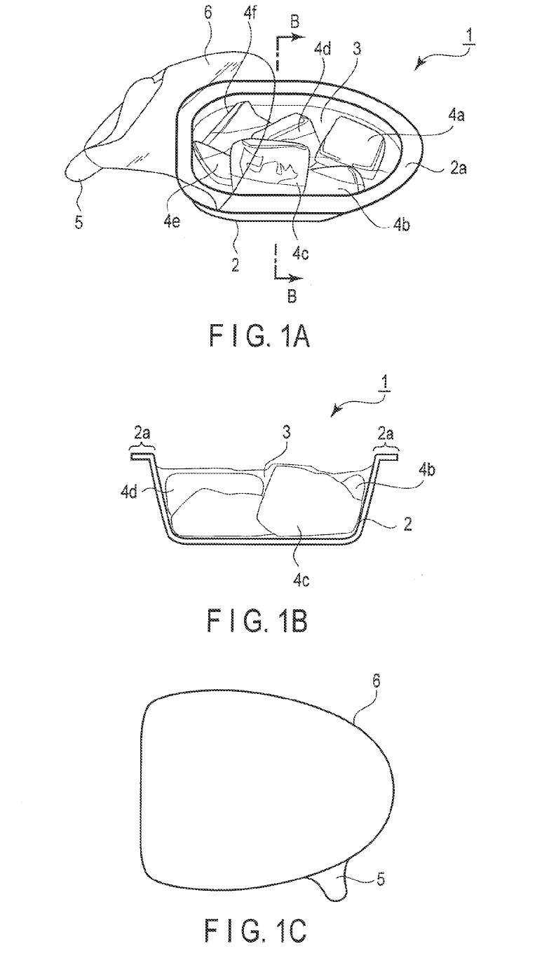

Now, an explanation will be given of an example of an encased mousse-form food according to an embodiment, with reference to FIG. 1A, FIG. 1B, and FIG. 1C. FIG. 1A is a perspective view illustrating an encased mousse-form food. FIG. 1B is a sectional view taken along a line B-B. FIG. 1C is a plan view illustrating a lid.

The encased mousse-form food 1 comprises a container 2 including an opening and a flange 2a formed around the opening. The container 2 contains mousse-form solid bodies 4a to 4f put therein. Further, the container 2 contains a viscous liquid 3 that covers the circumference of each of the mousse-form solid bodies 4a to 4f. A lid 6 including a tongue portion 5 is attached to the flange 2a of the container 2, so that the mousse-form solid bodies 4a to 4f and the viscous liquid 3 are sealed inside the container 2. FIG. 1A illustrates an example where the lid 6 is made of a transparent plastic film.

Before being served for eating, the lid 6 is removed from the container 2 by a user with fingers picking up the tongue portion 5. FIG. 1A illustrates a state where the lid 6 is partly detached from the flange 2a of the container 2.

FIG. 1A and FIG. 1B illustrate the plurality of mousse-form solid bodies 4a to 4f, but only one or more than one mousse-form solid bodies may be contained inside the container 2. Hereinafter, the mousse-form solid bodies 4a to 4f are collectively mentioned as a mousse-form solid body 4. In the case where a plurality of mousse-form solid bodies 4 are contained inside the container 2, these mousse-form solid bodies 4 may be of different types or may be of the same type.

The mousse-form solid body 4 has a hardness of 1.0×10⁴ N/m² or more and 5.0×10⁴ N/m² or less. The mousse-form solid body 4 is easy for a consumer to swallow.

For example, the mousse-form solid body 4 may be produced as follows: At first, materials are selected. The materials may be selected from animal food materials and vegetable food materials. For example, the materials may be meats, fish and shellfish, cereals, vegetables, seaweed, fruits, nuts and/or insects, or may be any of the substances used as food materials in general.

For example, the selected materials are ground to form material particles. A binding agent is added to the material particles, and they are mixed with each other, and heated as needed, to form a mousse-form solid body 4 having a specific hardness. Depending on the type of the binding agent, a process, such as heating, may be performed after stirring.

For example, the binding agent may be at least one selected from the group consisting of egg albumen, starch, and dextrin.

In the case of egg albumen and/or starch and/or dextrin, it is preferable to perform a heating process by steaming under conditions including a temperature of 70 to 80° C. and a humidity of 100%, for example. In this case, it suffices if the heating time is a time period sufficient to make the temperature of the mousse-form solid body uniform up to the inside and to solidify the mousse-form solid body over the entirety thereof. Thereafter, the mousse-form solid body may be cooled at room temperature or at a lower temperature, and/or cooled in water. Due to this heating, the final product or food may contain egg albumen and/or starch and/or dextrin in a thermally denatured state.

Further, before, during, or after the time period of mixing the material particles with the binding agent, they may be further mixed with desired additives, such as substances used for foods in general, which are, for example, seasonings, such as salt, sugar, soy sauce, and vinegar, and/or food additives, such as oil, thickener, perfume, and red food coloring.

The hardness of the mousse-form solid body 4 may be measured by use of an apparatus that can measure the compression stress of a substance by linear motion, along with a compression speed of 10 mm/sec and a measurement temperature of 20±2° C. This measurement is performed by use of a plunger having a diameter of, e.g., 3 mm, under a clearance of, e.g., 3 mm.

Further, the mousse-form solid body 4 provides smooth palate feeling when being eaten. This smooth palate feeling of the mousse-form solid body 4 may be achieved by reducing the diameter of the material particles contained in the mousse-form solid body. The material particles contained in the mousse-form solid body 4 may have a diameter of 1.5 mm, 0.5 mm or less, or 0.3 mm or less, and preferably of 0.1 mm or less.

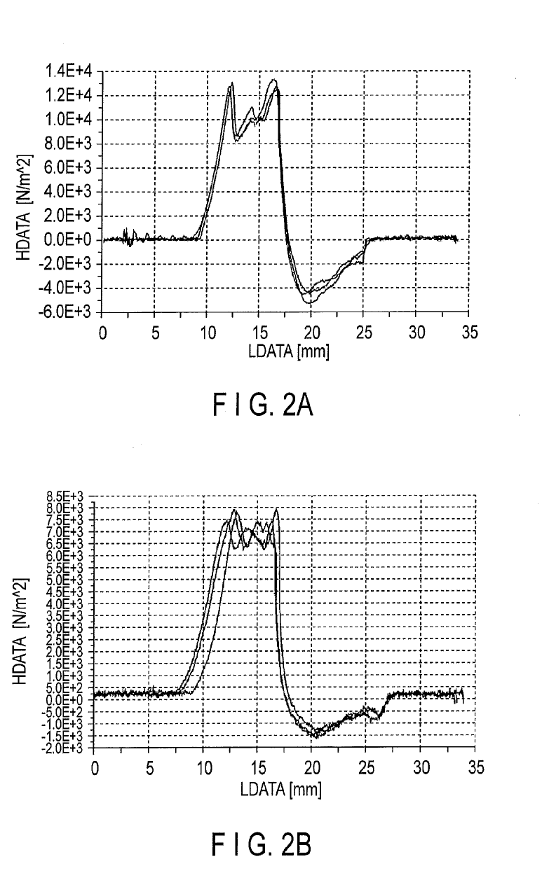

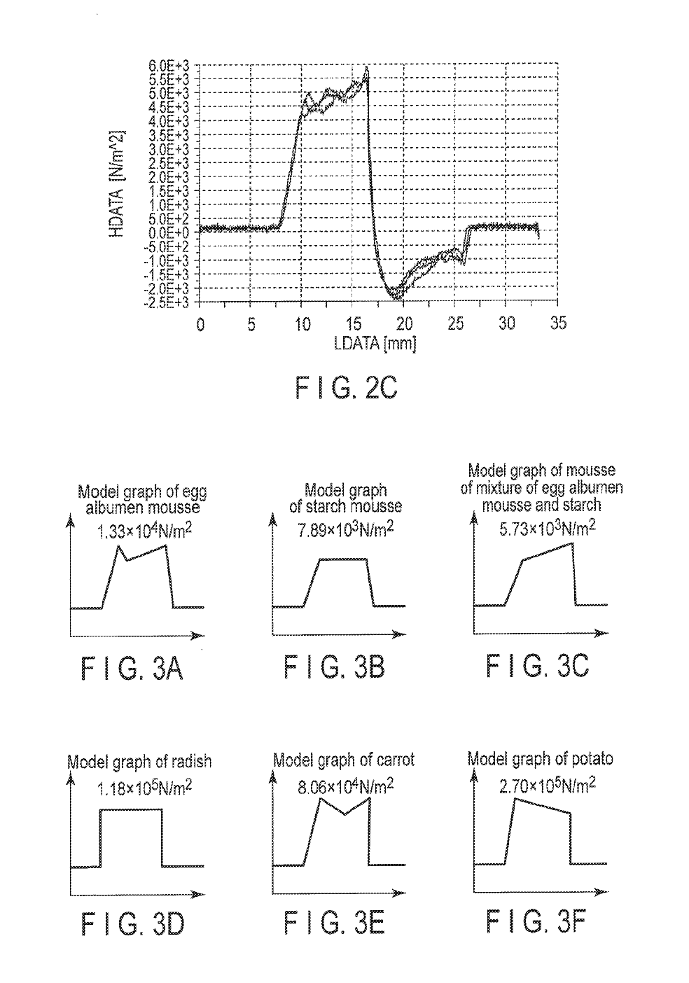

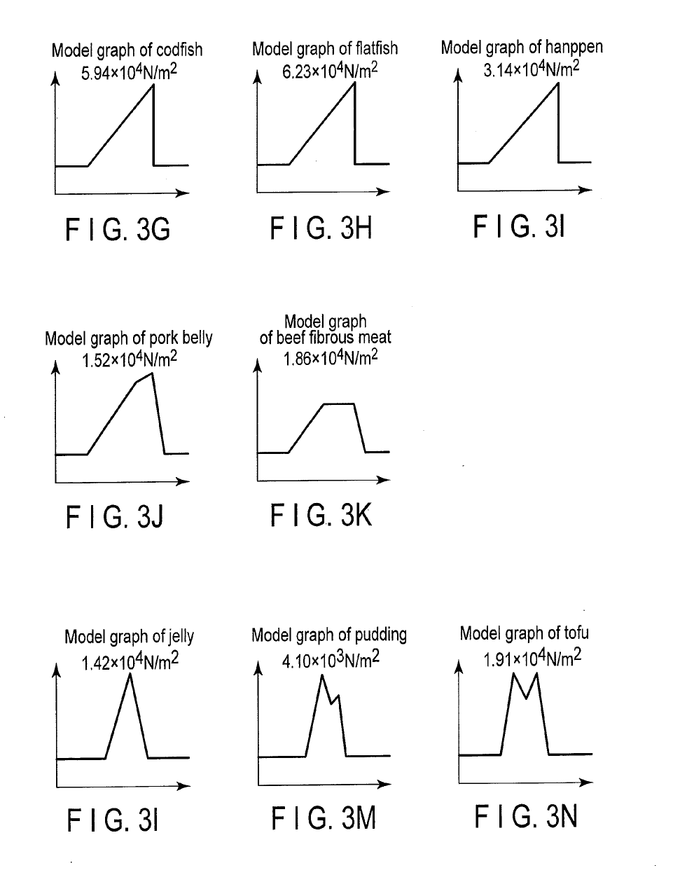

FIG. 2A to 2C show results of measurement performed on three examples of different types of the mousse-form solid body 4 by use of the above-described apparatus. The measurement was performed as follows: Each mousse-form solid body was cut to have a thickness of 1 cm, and then its hardness was measured in TENSIPRESSER My Boy II system (manufactured by Taketomo Electric Inc.), by use of a plunger having a diameter of 3 mm, along with a measurement temperature of 20±2° C., a compression speed of 10 mm/sec, and a clearance of 30% of the sample thickness, i.e., a clearance of 3 mm. In the graphs FIG. 2A to 2C, the vertical axis denotes the stress and the horizontal axis denotes the plunger travel distance. Model graphs were formed from these graphs and are shown in FIG. 3A to 3C. Thus, the model graphs of FIG. 3A to 3C correspond respectively to graphs in FIG. 2A to 2C. Further, for reference, FIG. 3D to 3N includes model graphs obtained in the same way from the following foods: FIG. 3D boiled radish, FIG. 3E boiled carrot, FIG. 3F boiled potato, FIG. 3G boiled codfish, FIG. 3H boiled flatfish, FIG. 3I boiled hanppen, FIG. 3J boiled pork belly, FIG. 3K boiled beef fibrous meat, FIG. 3L jelly, FIG. 3M pudding, and FIG. 3N firm tofu. The stress numerical value indicated in each of the model graphs denotes the stress maximum value in the model graph.

The mousse-form solid body 4 has a hardness almost uniform over the entirety thereof. Immediately after a physical force is applied to the mousse-form solid body 4, the rising of stress is gradual and constant. On the other hand, an appropriate stress needs to be applied to press and crush the mousse-form solid body 4.

The viscous liquid 3 has a viscosity of 0.5 Pa·s or more and 10.0 Pa·s or less, and preferably of 1.5 Pa·s or more and 2.0 Pa·s or less. Further, the relationship between the hardness of the mousse-form solid body 4 and the viscosity of the viscous liquid 3 preferably satisfies the condition defined by the following Formula I or Formula II, where the viscosity of the viscous liquid 3 is denoted by T and the hardness of the mousse-form solid body 4 is expressed by H×10⁴ N/m².

In the case where the hardness of the mousse-form solid body 4 is within 1.0≦H≦2.0, the following formula is satisfied.

T≦−H+2.5 (Formula I)

In the case where the hardness of the mousse-form solid body 4 is within 2.0<H≦5.0, the following formula is satisfied.

T≧0.5 (Formula II)

The viscosity was measured by use of a B-type rotational viscometer, in which the rotor was rotated at a specific number of revolutions, such as 12 rpm, and the indicated value was read after two minutes. This value was multiplied by a corresponding count, and the resultant value thus obtained was expressed with “Pa·s”. This measurement may be performed at a temperature of 20±2° C.

Since the circumference of the mousse-form solid body 4 is entirely covered with the viscous liquid 3 having such a viscosity, the mousse-form solid body 4 is prevented from collapsing during transportation.

For example, the ratio between the total volume of the viscous liquid 3 and the total volume of the mousse-form solid body 4 inside the container 2 may be set at 2:8 to 5:5 and preferably at 3:7 to 4:6. The total volume of the mousse-form solid body 4 mentioned here means the total of the volumes of all the mousse-form solid bodies 4 contained inside the container 2. Specifically, when a single mousse-form solid body 4 is contained inside one container 2, the total volume is the volume of this single mousse-form solid body 4. On the other hand, when a plurality of mousse-form solid bodies 4 are contained inside one container 2, the total volume is the total of the respective volumes of the plurality of mousse-form solid bodies 4. With an increase in the total volume of the mousse-form solid body 4, in relation to the ratio between the viscous liquid 3 and the mousse-form solid body 4, the mousse-form solid body 4 becomes less apt to collapse. This is because the movable range of the mousse-form solid body 4 inside the container 2 becomes smaller, with an increase in the total volume of the mousse-form solid body 4. However, if the viscous liquid 3 is too little, it becomes difficult to provide a function as a seasoning liquid. On the other hand, if the viscous liquid 3 is too much, the mousse-form solid body 4 is given a larger movable range and becomes more apt to collapse. Further, in this case, since the ingredient looks smaller, the appearance becomes poorer.

The viscous liquid 3 may be prepared as follows: For example, the viscous liquid 3 is obtained by adding a thickening stabilizer to a seasoning liquid containing water and seasonings, and then mixing them with each other. Depending on the type of the thickening stabilizer, a process necessary for dissolution, such as warming and/or stirring, may be performed. Further, in order to obtain a specific viscosity, a process, such as warming, cooling, stirring, and/or pH-adjusting, may be performed.

Although not limiting, an example of the thickening stabilizer is pectin, guar gum, xanthan gum, tamarind gum, carrageenan, carboxymethylcellulose, tara gum, locust bean gum, curdlan, gelatin, agar, sodium alginate, psyllium seed gum, gellan gum, Arabic gum, karaya gum, chitin, chitosan, arabinogalactan, welan gum, sesbania gum, Aloe vera extract, Erwinia mitsuensis gum, daruman resin, ghatti gum, elemi resin, dextran, enterobacter simanus gum, enterobacter gum, triacanthos gum, oligoglucosamine, Abelmoschus manihot, microfibrous cellulose, tragacanth gum, Bacillus subtilis natto gum, Gloiopeltis furcata extract, furcellaran, cassia gum, macrophomopsis gum, pullulan, Aloe arborescens extract, peach resin, Aureobasidium culture solution, guar gum enzymolysis product, ramsan gum, aeromonas gum, glucosamine, levan, Agrobacterium succinoglycan, yeast cell film, linseed gum, Azotobacter vinelandii gum, Artemisia seed gum, almond gum, and/or sclero gum.

The thickening stabilizer may be selected in consideration of the properties of respective thickening stabilizers, as shown in TABLE 1, the other component composition contained in the viscous liquid, and/or whether the encased mousse-form solid food is to be heated before being served for eating.

TABLE 1
Type and Feature of Thickening Stabilizer

| Type of | | | | | |
|---|---|---|---|---|---|
| thickening | Acid | Alkali | Heat | | Solubility |
| stabilizer | resistance | resistance | resistance | Flow viscosity | in water |
| Guar gum | Δ | ◯ | Δ | Pseudoplastic | Soluble even |
| | | | | | in cold water |
| Xanthan gum | ◯ | ◯ | ◯ | Pseudoplastic | Soluble even |
| | | | | | in cold water |
| Tamarind | ◯ | ◯ | ◯ | Newtonian | Soluble |
| gum | | | | viscous | by heating |
| Carrageenan | Δ | ◯ | ◯ | Thixotropic | Only λ is soluble |
| | | | | Iota type is | The others are |
| | | | | pseudoplastic | soluble by warming |
| | | | | Lambda type is | |
| | | | | pseudoplastic | |
| Tara gum | Δ | ◯ | ◯ | — | Soluble by |
| | | | | | warming |
| Locust | ◯ | ◯ | ◯ | Pseudoplastic | Soluble by |
| bean gum | | | | | warming |
| Sodium | Turned into | X | ◯ | Pseudoplastic | Soluble even |
| alginate | alginic acid | | | close to | in cold water |
| | by acidity | | | Newtonian | |
| | and forming | | | viscous | |
| | gel | | | | |
| Gellan gum | ◯ | ◯ | ◯ | Pseudoplastic | Soluble by |
| | | | | | warming |

◯: Yes X: no Δ: Yes in some cases —: No data

Preferably, the thickening stabilizer is pectin, guar gum, xanthan gum, tamarind gum, carrageenan, carboxymethylcellulose, tara gum, locust bean gum, curdlan, gelatin, agar, sodium alginate, psyllium seed gum, gellan gum, Arabic gum, karaya gum, chitin, and/or chitosan. More preferably, the thickening stabilizer is xanthan gum, guar gum, tamarind gum, tara gum, gellan gum, and/or sodium alginate. Most preferably, the thickening stabilizer is xanthan gum.

The container 2 may be any one of a plastic container, metal container, glass container, ceramic container, and waterproof paper container, as long as the container can maintain a certain form during its manufacture, transportation, and use for, e.g., eating.

The container 2 may be a container having any shape selected from well known ones, such as a cup type, bowl type, and ship type; a cylindrical shape with an opening; a circular column shape, polygonal column shape, circular cone shape, and polygonal cone shape, each of which is hollow; and a circular cone shape and polygonal cone shape, each of which is truncated and hollow. The container 2 may be produced by use of any technique selected from well known ones, in accordance with a material and shape selected for the container.

The lid 6 is a member that covers the opening of the container 2 to seal the mousse-form solid body 4 and the viscous liquid 3 contained inside the container 2. It suffices if the lid 6 at least has a shape and size necessary for covering the entirety of the opening of the container 2. In the example described above, the lid 6 includes the tongue portion 5, but the tongue portion 5 may be omitted. Further, the size of the lid 6 may be set to be larger than the circumference of the flange 2a of the container 2. In this case, a user can pull away the lid 6 from the container 2 by holding, with fingers, that part of the lid 6 which extends outward from the flange 2a.

The lid 6 may be made of a material the same as that of the container 2 or different from that of the container 2. The material of the lid 6 may be selected from plastic, metal, glass, ceramic, and waterproof paper. The lid 6 may be attached to the container 2 by any one of adhering, fitting, heat sealing, double seaming, screw cap, and wax sealing.

For example, an encased mousse-form solid food may be manufactured as follows: Materials are ground into particles having a diameter of 0.1 mm or less and thereby turned into a paste. Egg albumen and/or starch are added to the paste thus formed, and they are mixed with each other. The resultant mixture is heated, and a mousse-form solid body is thereby obtained. A seasoning liquid is provided. The seasoning liquid is set to have a viscosity of 0.5 Pa·s or more and 10.0 Pa·s or less, and a viscous liquid is thereby prepared. The viscous liquid and the mousse-form solid body are put in a container. A lid is attached to the container.

The encased mousse-form solid food 1 may be provided as any one of a side dish, main dish, and confectionery.

According to the present invention, there is provided an encased mousse-form food that does not require freezing for distribution. In general, a nursing facility or the like accommodates a lot of persons to be nursed, and so it needs to provide a large quantity of meal at a time. In the case of conventional foods that are distributed in a frozen state and are thawed before being served for eating, a large amount of labor is required for the thawing operation. On the other hand, the encased mousse-form solid food according to the present invention can be distributed in an unfrozen state, and thus can be served for eating only by removing the lid, for example. Further, since the mousse-form solid body is used, the encased mousse-form solid food makes it possible for consumers to enjoy even the taste of a food having a complicated feature using various materials. In this case, it is possible to easily manufacture such an encased mousse-form solid food. Further, even in the case of a cuisine that requires labor for cooking, such as a simmered dish, the encased mousse-form solid food makes it possible to reproduce the taste of the cuisine without damaging the taste, while keeping the tastes of respective materials. Also in this case, it is possible to easily manufacture such an encased mousse-form solid food. Thus, the encased mousse-form solid food makes it possible for consumers to enjoy even the taste of a cuisine that requires labor.

The present invention is more effective to prevent a food comprising a very soft solid body of 5.0×10⁴ N/m² or less from collapsing. Particularly, the present invention is highly effective to prevent a food comprising a solid body formed of protein or starch from collapsing.

The encased mousse-form solid food according to the present invention utilizes the viscosity of the liquid to reduce vibration during transportation and to prevent the solid food from moving inside the container. Accordingly, it is possible to prevent the mousse-form solid body from collapsing, which can be caused when the mousse-form solid body comes into contact with the inner surface of the container, or when mousse-form solid bodies come into contact with each other. Further, since the food can be prevented from collapsing by a necessary minimum viscosity, the viscous thickness becomes minimally influential even in the case where the food is applied to a type that is not preferably thickened.

### EXAMPLE

1. Mousse-Form Solid Body

1) Dried Egg Albumen Mousse

Dried egg albumen (dried egg albumen W-type produced by Kewpie Egg Corporation) was dissolved by mixing and stirring it with water. The object thus obtained was put in a container serving as a heat-proof mold, such as a cake mold, and was hardened by steaming for 25 minutes in a steamer (Healsio manufactured by Sharp Corporation). The object thus hardened was cooled, and then cut into a size of 20×20×7 mm. This resultant product was defined as a mousse-form solid body according to a present example 1.

In the process described above, the added amount of the dried egg albumen employed there was varied at weight percent concentrations of 7.29, 7.49, 7.69, 8.08, 8.28, and 11.24. The mousse-form solid bodies thus obtained respectively had hardnesses of 1.0×10⁴ N/m², 1.2×10⁴ N/m₂, 1.4×10⁴ N/m², 1.8×10⁴ N/m², 2.0×10⁴ N/m², and 5.0×10⁴ N/m². These mousse-form solid bodies were respectively defined as a sample 1, sample 2, sample 3, sample 4, sample 5, and sample 6.

The hardness of each of these mousse-form solid bodies was measured in a texture meter (TENSIPRESSER My Boy II system manufactured by Taketomo Electric Inc.). The measurement was performed under conditions employing a plunger having a diameter of 3 mm, along with a measurement temperature of 20±2° C., a compression speed of 10 mm/sec, and a clearance of 2.1 mm.

2) Starch Mousse

Janef mousse jelly powder (plain type produced by Kewpie Egg Corporation) was put in water and lightly boiled by heating to be well dissolved. The object thus dissolved was put in a cake mold serving as a heat-proof mold, and was hardened by leaving and cooling it. The object thus hardened was cut into a size of 20×20×7 mm. This resultant product was defined as a mousse-form solid body according to a present example 2.

In the process described above, the added amount of the Janef mousse jelly powder employed there was varied at weight percent concentrations of 22.4, 23.3, 24.2, 25.9, 26.8, and 39.9. The mousse-form solid bodies thus obtained respectively had hardnesses of 1.0×10⁴ N/m², 1.2×10⁴ N/m², 1.4×10⁴ N/m², 1.8×10⁴ N/m², 2.0×10⁴ N/m² and 5.0×10⁴ N/m². These mousse-form solid bodies were respectively defined as a sample 7, sample 8, sample 9, sample 10, sample 11, and sample 12.

The hardness of each of these mousse-form solid bodies was measured in a texture meter (TENSIPRESSER My Boy II system manufactured by Taketomo Electric Inc.). The measurement was performed under conditions employing a plunger having a diameter of 3 mm, along with a measurement temperature of 20° C., a compression speed of 10 mm/sec, and a clearance of 2.1 mm.

2. Viscous Liquid

In order to perform a vibration test, a viscous liquid was prepared by use of tamarind gum. A solution of the tamarind gum has properties according to a Newtonian fluid. The tamarind gum (glyloid 3S produced by DSP Gokyo Food & Chemical Co., Ltd.) was dissolved in water by use of hand mixer. In order to settle the viscosity of the viscous liquid, the object thus dissolved was left in a refrigerator overnight, and then returned to normal temperature (20° C.)

In the process described above, the added amount of the tamarind gum employed there was varied at weight percent concentrations of 0.20, 0.49, 0.78, 1.22, 1.37, 1.66, 1.95, 2.10, 2.68, 7.07, and 14.37. The viscous liquids thus obtained respectively had viscosities of 0.3 Pa·s, 0.5 Pa·s, 0.7 Pa·s, 1.0 Pa·s, 1.1 Pa·s, 1.3 Pa·s, 1.5 Pa·s, 1.6 Pa·s, 2.0 Pa·s, 5.0 Pa·s, and 10.0 Pa·s. These viscous liquids were respectively defined as a sample 13, sample 14, sample 15, sample 16, sample 17, sample 18, sample 19, sample 20, sample 21, sample 22, and sample 23.

The viscosity was measured by use of a B-type viscometer (manufactured by Toki Sangyo Co., Ltd.), (along with use of M3 rotor, 12 rpm, and 20° C.)

3. Filling

Plastic cups, each having a capacity of 50 mL and including an opening and a flange formed around the opening, were used as containers. The mousse-form solid bodies of the samples 1 to 12 were respectively put in the containers, such that each of these types consisted of 4 pieces. One of the viscous liquids of the samples 13 to 23 was introduced, in an amount of 35 mL, into each of the containers. A lid formed of a film was placed on the flange of each of the containers, and was then sealed by ironing. Each of the containers had a head space of 3.8 mL. The encased mousse-form solid foods thus obtained were respectively defined as encased mousse-form solid foods.

4. Box for Testing Vibration

A shallow tray was partitioned by use of cardboards so that cups for nursing care foods could be placed thereon without a space between them. This tray was used as a box for testing vibration.

5. Vibration Test

The box for testing vibration was placed on a vibration testing machine. The encased mousse-form solid foods manufactured by filling the containers as described above were respectively put in the spaces surrounded by the partitions inside the box for testing vibration. The box for testing vibration was capped and was then fixed to the vibration testing machine by a rope.

The vibration test conditions were set as follows:

5 Hz×20 mm (corresponding to 1 G),

Vertical vibration for 50 minutes, and

Horizontal vibration for 10 minutes.

These conditions are in line with JIS Z 0200, Packaged Freight, Evaluation Testing Method.

After the vibration test, the lid was pulled away from each of the containers, and then each of the mousse-form solid bodies was visually confirmed as to whether it had collapsed.

TABLE 2

| Viscosity of | | Hardness of mousse-form solid body (×10⁴ N/m²) | | | | | |
|---|---|---|---|---|---|---|---|
| viscous liquid | | Sample 6 | Sample 5 | Sample 4 | Sample 3 | Sample 2 | Sample 1 |
| (Pa · s) | | 5.0 | 2.0 | 1.8 | 1.4 | 1.2 | 1.0 |
| Sample | 10.0 | ◯ | ◯ | ◯ | ◯ | ◯ | ◯ |
| 23 | | | | | | | |
| Sample | 5.0 | ◯ | ◯ | ◯ | ◯ | ◯ | ◯ |
| 22 | | | | | | | |
| Sample | 2.0 | ◯ | ◯ | ◯ | ◯ | ◯ | ◯ |
| 21 | | | | | | | |
| Sample | 1.6 | ◯ | ◯ | ◯ | ◯ | ◯ | ◯ |
| 20 | | | | | | | |
| Sample | 1.5 | ◯ | ◯ | ◯ | ◯ | ◯ | ◯ |
| 19 | | | | | | | |
| Sample | 1.3 | ◯ | ◯ | ◯ | ◯ | ◯ | Δ |
| 18 | | | | | | | |
| Sample | 1.1 | ◯ | ◯ | ◯ | ◯ | Δ | Δ |
| 17 | | | | | | | |
| Sample | 1.0 | ◯ | ◯ | ◯ | Δ | Δ | Δ |
| 16 | | | | | | | |
| Sample | 0.7 | ◯ | ◯ | ◯ | Δ | Δ | Δ |
| 15 | | | | | | | |
| Sample | 0.5 | ◯ | ◯ | Δ | Δ | Δ | Δ |
| 14 | | | | | | | |
| Sample | 0.3 | ◯ | Δ | X | X | X | X |
| 13 | | | | | | | |
| Viscosity of | | Hardness of mousse-form solid body (×10⁴ N/m²) | | | | | |
| viscous liquid | | Sample 12 | Sample 11 | Sample 10 | Sample 9 | Sample 8 | Sample 7 |
| (Pa · s) | | 5.0 | 2.0 | 1.8 | 1.4 | 1.2 | 1.0 |
| Sample | 10.0 | ◯ | ◯ | ◯ | ◯ | ◯ | ◯ |
| 23 | | | | | | | |
| Sample | 5.0 | ◯ | ◯ | ◯ | ◯ | ◯ | ◯ |
| 22 | | | | | | | |
| Sample | 2.0 | ◯ | ◯ | ◯ | ◯ | ◯ | ◯ |
| 21 | | | | | | | |
| Sample | 1.6 | ◯ | ◯ | ◯ | ◯ | ◯ | ◯ |
| 20 | | | | | | | |
| Sample | 1.5 | ◯ | ◯ | ◯ | ◯ | ◯ | ◯ |
| 19 | | | | | | | |
| Sample | 1.3 | ◯ | ◯ | ◯ | ◯ | ◯ | Δ |
| 18 | | | | | | | |
| Sample | 1.1 | ◯ | ◯ | ◯ | ◯ | Δ | Δ |
| 17 | | | | | | | |
| Sample | 1.0 | ◯ | ◯ | ◯ | Δ | Δ | Δ |
| 16 | | | | | | | |
| Sample | 0.7 | ◯ | ◯ | ◯ | Δ | Δ | Δ |
| 15 | | | | | | | |
| Sample | 0.5 | ◯ | ◯ | Δ | Δ | Δ | Δ |
| 14 | | | | | | | |
| Sample | 0.3 | ◯ | Δ | X | X | X | X |
| 13 | | | | | | | |

◯: collapsed Δ: slightly collapsed X: not collapsed

In any of the samples using the dried egg albumen mousses according to the present example 1 and the starch mousses according to the present example 2, the following results were observed, as described with reference to the following formulas, where H(×10⁴ N/m²) denotes the hardness of the mousse-form solid body and T denotes the viscosity of the viscous liquid.

Within a range of 1.0≦H≦2.0, each mousse-form solid body did not collapse when it satisfied the following formula.

T≧H+2.5

Within a range of 2.0<H≦5.0, each mousse-form solid body did not collapse when it satisfied the following formula.

T≧0.5

According the test described above, it has become clear that an encased mousse-form food that does not require freezing for distribution can be applied.

### EXPLANATION OF REFERENCE SYMBOLS

1. Encased mousse-form solid food

2. Container

2a. Flange

3. Viscous liquid

4. Mousse-form solid body

5. Tongue portion

6. Lid

What is claimed is:

1. An encased mousse-form solid food comprising:
a container with an opening;
a mousse-form solid body contained inside the container;
a viscous liquid contained inside the container and covering a circumference of the mousse-form solid body; and
a lid attached to the opening of the container, wherein the mousse-form solid body has a hardness of 1.0×10⁴ N/m² or more and 5.0×10⁴ N/m² or less, and the viscous liquid has a viscosity of 0.5 Pa·s or more and 10.0 Pa·s or less.

2. The food according to claim 1, wherein, where the viscosity of the viscous liquid is denoted by T, and the hardness of the mousse-form solid body is expressed by H×10⁴,
a following formula is satisfied within a range of 1.0≦H≦2.0,
T≧−H+2.5 (Formula I), or
a following formula is satisfied within a range of 2.0<H≦5.0,
T≧0.5.

3. The food according to claim 1, wherein the viscosity of the viscous liquid is 1.5 Pa·s or more and 2.0 Pa·s or less.

4. The food according to claim 1, wherein the mousse-form solid body includes material particles having a diameter of 0.1 mm or less, and a binding agent for the material particles, which is at least one selected from the group consisting of egg albumen, starch, and dextrin.

5. The food according to claim 1, wherein the egg albumen, the starch, and the dextrin are egg albumen, starch, and dextrin that are in a thermally denatured state.

6. The food according to claim 1, wherein a ratio between a total volume of the viscous liquid and a total volume of the mousse-form solid body inside the container is set at 2:8 to 5:5.

7. The food according to claim 1, wherein the food is a side dish.

8. A method for manufacturing an encased mousse-form solid food, the method comprising:
(a) forming a paste by grinding a material into particles having a diameter of 0.1 mm or less;
(b) mixing the paste formed in the (a) with an added matter that is at least one selected from the group consisting of egg albumen, starch, and dextrin;
(c) heating a mixture formed by mixing in the (b), thereby obtaining a mousse-form solid body;
(d) providing a seasoning liquid;
(e) setting the seasoning liquid to have a viscosity of 0.5 or more and 10.0 Pa·s or less, thereby preparing a viscous liquid;
(f) putting the viscous liquid and the mousse-form solid body in a container; and
(g) attaching a lid to the container.

9. The method according to claim 8, wherein, where the viscosity of the viscous liquid is denoted by T, and the hardness of the mousse-form solid body is expressed by H×10⁴,
a following formula is satisfied within a range of 1.0≦H≦2.0,
T≧−H+2.5 (Formula I), or
a following formula is satisfied within a range of 2.0<H≦5.0,
T≧0.5.

10. The method according to claim 8, wherein the viscosity of the viscous liquid is 1.5 Pa·s or more and 2.0 Pa·s or less.

11. The method according to claim 8, wherein the setting of the viscosity in the (e) includes adding a thickening stabilizer to the seasoning liquid.

12. The method according to claim 8, wherein a ratio between a total volume of the viscous liquid and a total volume of the mousse-form solid body inside the container is set at 2:8 to 5:5.

13. The method according to claim 8, wherein the encased mousse-form solid food is a side dish.
